(19) United States
(12) Patent Application Publication
(10) Pub. No.: US 2006/0112301 A1
(43) Pub. Date: May 25, 2006

(54) Method and computer program product to improve I/O performance and control I/O latency in a redundant array

(75) Inventor: Jeffrey Wong, Newton, MA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/982,911

(22) Filed: Nov. 8, 2004

(51) Int. Cl. G06F 11/00

(52) U.S. Cl. 714/6

(57) ABSTRACT

A method and computer program product for improving I/O performance and controlling I/O latency for reading or writing to a disk in a redundant array, comprising determining an optimal number of I/O sort queues, their depth and a latency control number, directing incoming I/Os to a second sort queue if the queue depth or latency control number for the first queue is exceeded, directing incoming I/Os to a FIFO queue if all sort queues are saturated and issuing I/Os to a disk in the redundant array from the sort queue having the foremost I/Os.

### FIELD OF THE INVENTION

The disclosed invention relates to RAID controllers and more specifically to improving I/O performance and controlling I/O latency for a RAID array.

### BACKGROUND OF INVENTION

There are many applications, particularly in a business environment, where there are needs beyond what can be fulfilled by a single hard disk, regardless of its size, performance or quality level. Many businesses can't afford to have their systems go down for even an hour in the event of a disk failure. They need large storage subsystems with capacities in the terabytes. And they want to be able to insulate themselves from hardware failures to any extent possible. Some people working with multimedia files need fast data transfer exceeding what current drives can deliver, without spending a fortune on specialty drives. These situations require that the traditional “one hard disk per system” model be set aside and a new system employed. This technique is called Redundant Arrays of Inexpensive Disks or RAID. (“Inexpensive” is sometimes replaced with “Independent”, but the former term is the one that was used when the term “RAID” was first coined by the researchers at the University of California at Berkeley, who first investigated the use of multiple-drive arrays in 1987. See D. Patterson, G. Gibson, and R. Katz. “A Case for Redundant Array of Inexpensive Disks (RAID)”, Proceedings of ACM SIGMOD '88, pages 109-116, June 1988.

The fundamental structure of RAID is the array. An array is a collection of drives that is configured, formatted and managed in a particular way. The number of drives in the array, and the way that data is split between them, is what determines the RAID level, the capacity of the array, and its overall performance and data protection characteristics.

An array appears to the operating system to be a single logical hard disk. RAID employs the technique of “striping”, which involves partitioning each drive's storage space into units ranging from a sector (512 bytes) up to several megabytes. The stripes of all the disks are interleaved and addressed in order.

In a single-user system where large records, such as medical or other scientific images, are stored, the stripes are typically set up to be relatively small (perhaps 64 k bytes) so that a single record often spans all disks and can be accessed quickly by reading all disks at the same time.

In a multi-user system, better performance requires establishing a stripe wide enough to hold the typical or maximum size record. This allows overlapped disk I/O (Input/Output) across drives.

Most modern, mid-range to high-end disk storage systems are arranged as RAID configurations. A number of RAID levels are known. RAID-0 “stripes” data across the disks. RAID-1 includes sets of N data disks and N mirror disks for storing copies of the data disks. RAID-3 includes sets of N data disks and one parity disk, and is accessed with synchronized spindles with hardware used to do the striping on the fly. RAID-4 also includes sets of N+1 disks, however, data transfers are performed in multi-block operations. RAID-5 distributes parity data across all disks in each set of N+1 disks. RAID levels 10, 30, 40, and 50 are hybrid levels that combine features of level 0, with features of levels 1, 3, 4 and 5. One description of RAID types can be found at http://searchstorage.techtarget.com/sDefinition/0,,sid5_gci214332,00.html.

Thus RAID is simply several disks that are grouped together in various organizations to either improve the performance or the reliability of a computer's storage system. These disks are grouped and organized by a RAID controller.

All I/O to a redundant array is through the RAID controller. I/O requests for a disk in a redundant array originate from an application and are conveyed by the OS (Operating System) to the RAID controller. These I/O requests are then issued by the RAID controller to respective disks in the array. Conventional method of improving I/O performance by using a sorted queue

A common method to improve random I/O performance in a redundant array involves sorting the I/Os before issuing them to respective disks in the array. I/Os are sorted according to their read or write location on the disk, thereby optimizing movement of the disk's head and reducing I/O processing delays. While this does reduce movement of the disk's head, it is however an “unfair algorithm” in that it will continuously sort new I/Os ahead of previously received I/Os if the read or write location for the new I/Os precedes that of the previously received I/Os. This is not an issue if the incoming I/O rate is low. However, if the incoming I/O rate is high, then possibly an excessive number of new I/Os are sorted before previously received I/Os, thereby creating an unfair algorithm. Thus while head movement is minimized, existing I/Os in the queue might have to wait longer than necessary to be processed. Alternatively, I/Os can be processed in the order they were received, thereby providing a first come first served methodology. However, the tradeoff is excessive disk head movement which results in increased I/O latency. A “fair algorithm” would be able to provide reasonable priority to foremost I/Os while minimizing disk head movement.

What is needed is a new method to improve I/O performance and control I/O latency when issuing I/Os to a redundant array.

### SUMMARY OF THE INVENTION

The invention comprises a method and computer program product for improving I/O performance and controlling I/O latency for reading or writing to a disk in a redundant array, comprising determining an optimal number of I/O sort queues, their depth and a latency control number, directing incoming I/Os to a second sort queue if the queue depth or latency control number for a first sort queue is exceeded, directing incoming I/Os to a FIFO queue if all sort queues are saturated and issuing I/Os to a disk in the redundant array from the sort queue having the foremost I/Os.

Additional features and advantages of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. The detailed description is not intended to limit the scope of the claimed invention in any way.

### DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a conventional sort queue.

FIG. 2 illustrates an exemplary I/O processing configuration.

FIGS. 3-9 illustrate different states of the I/Os and queues.

FIG. 10 illustrates a flowchart which shows the flow of I/Os from the queues to the disk.

FIG. 11 is a block diagram of a computer system on which the present invention can be implemented.

### DETAILED DESCRIPTION OF INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The invention uses n sort queues in combination with a First In First Out (FIFO) queue to improve I/O performance and control I/O latency by using an algorithm that provides fairness to previously received I/Os. A “latency control number” is used in the invention to control the switching of queues. The latency control number in conjunction with other parameters such as the number of sorted queues and queue depth are used to control latency and maintain a fair algorithm. The number of sorted queues, the queue depth and the latency control number are determined based on I/O request rates and I/O statistics. Each disk in the array has its own FIFO queue and n sort queues having corresponding queue depths and latency control numbers. The FIFO queue is sufficiently deep to accept all incoming I/Os that cannot be directed to a sort queue.

Incoming I/Os are initially stored in a first sort queue which sorts the I/Os according to read or write location to a disk. When either the queue depth or the latency control number for the queue is exceeded, it is said to be “saturated” or in the “saturated state”. When the queue is completely empty it is said to be “empty” or in the “empty state”. The queue remains in the saturated state till all stored I/Os have been issued and does not accept any new incoming I/Os till it is in the empty state. This ensures fairness in the algorithm by first issuing the foremost I/Os to a disk in the redundant array.

If the first sort queue enters the saturated state, incoming I/Os are transferred to the next sort queue. While the second sort queue is receiving I/Os, the first sort queue continues issuing I/Os to the disk. After the first sorted queue is empty, the second sort queue issues I/Os to the disk and so on.

If all the sort queues are in a saturated state, incoming I/O requests are directed towards the FIFO queue. When the first sort queue is empty, I/Os are transferred to it from the FIFO queue. If the first sort queue saturates before the FIFO queue has transferred all I/Os, then the FIFO queue transfers I/Os to the second sort queue when the second sort queue is empty and so on.

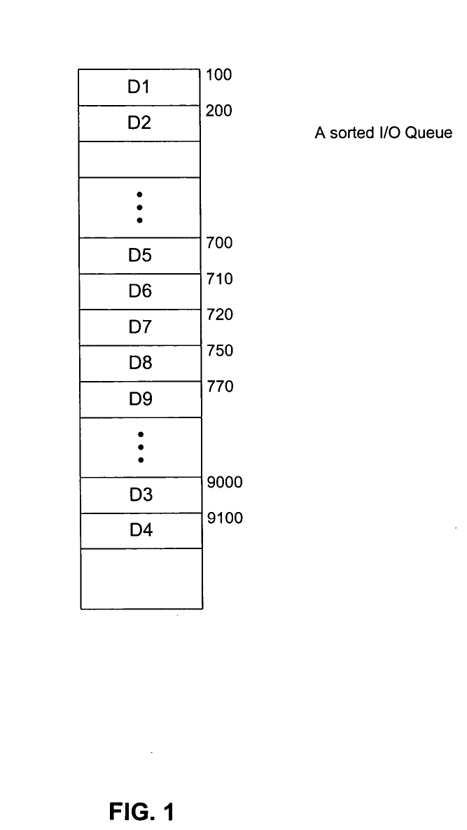

FIG. 1 shows a conventional system for issuing I/Os to disk which uses only one sort queue. This queue also sorts I/Os based on read or write locations to the hard disk. Sample disk read or write locations are indicated by the numbers 100, 200, 700, 710, 720, 750, 770, 9000, and 9100.

Assume there are nine I/O requests D1 to D9 (numbered in the order they were received) issued by the OS to the RAID controller. Consider a case where D1 is to be issued to disk location 100, D2 to location 200, D3 to location 9000, D4 to location 9100, D5 to location 700, D6 to location 710, D7 to location 720, D8 to location 750 and D9 to location 770. After issuing D1 and D2 to locations 100 and 200 respectively, the sort queue will not process D3 and D4 until D5 to D9 have been issued because D5 to D9 have been sorted ahead of D3 and D4 based on their issue location to disk. This will result in a severe delay in processing I/O requests D3 and D4 (since they were sorted to locations 9000 and 9100 respectively), even though they were received prior to I/O requests D5 through D9. If further I/Os, with issue locations prior to 9000 and 9100 are received, then D3 and D4 issue latency will increase significantly.

### EXEMPLARY EMBODIMENT

One aspect of the invention employs n sort queues in conjunction with a FIFO queue to overcome the processing delays mentioned above and to control I/O latency.

The latency control number, the number of sort queues and their depth are determined based on such factors as the frequency of I/O requests, I/O statistics and nature of the applications currently running. The latency control number determines if incoming I/Os need to be re-directed from the current sort queue to the next available sort queue. This number typically depends on the frequency of incoming I/Os. For example, if the I/O rate is extremely high, it is likely that some I/Os are being continuously sorted ahead of existing I/Os. In this case if the latency control number is exceeded (or if the queue depth is exceeded), the queue enters the saturated state and incoming I/O requests will be re-directed to the next sort queue (or the FIFO queue if all the sort queues are saturated).

It should be noted that parameters such as the number of queues, the queue depth and the latency control number or the method to determine these can be implemented in various forms in different embodiments of the invention by those skilled in the art without departing from the spirit and scope of the invention. It should also be noted that the invention is a combination of at least one sort queue in conjunction with a FIFO queue to control I/O latency and improve I/O performance by minimizing the disk's head movement and maintaining a fair algorithm. The terms storage device, hard disk drive or disk drive are used interchangeably throughout. The terms I/Os, incoming I/Os, incoming I/O requests and I/O requests refer to read or write requests received from the OS that are to be issued to a disk in the array after being sorted by a sort queue (whence they are referred to as sorted I/Os). Although this invention is directed towards improving I/O performance for disk drives controlled by a RAID controller, this invention can be implemented for any storage device that writes based on location.

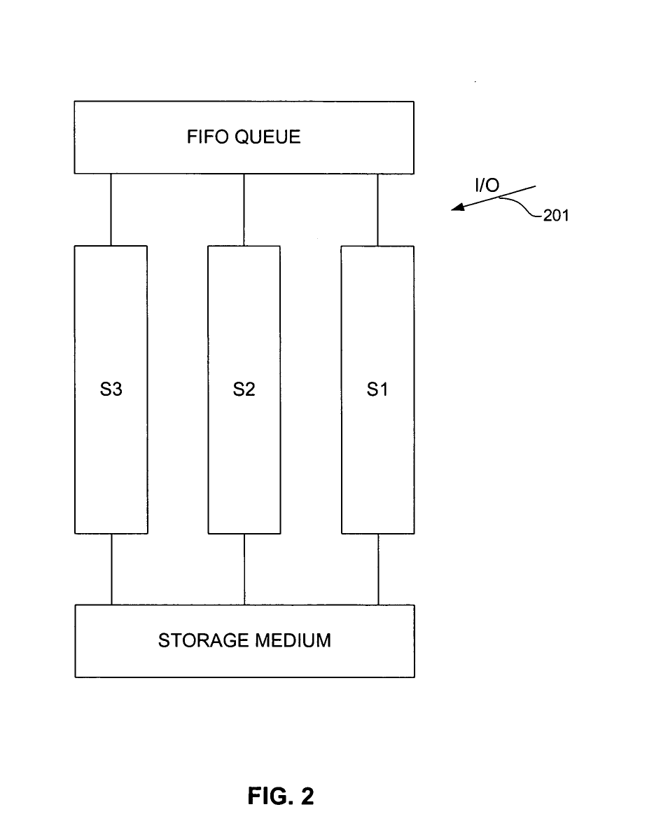

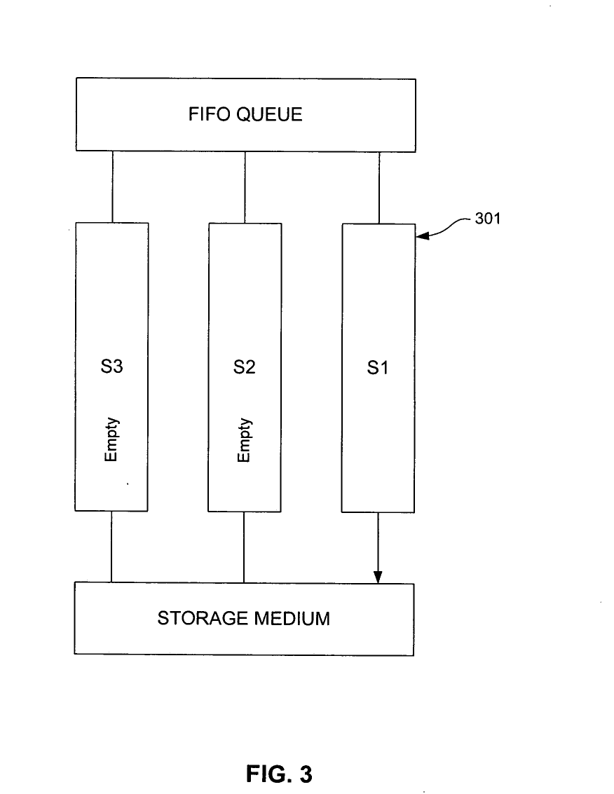

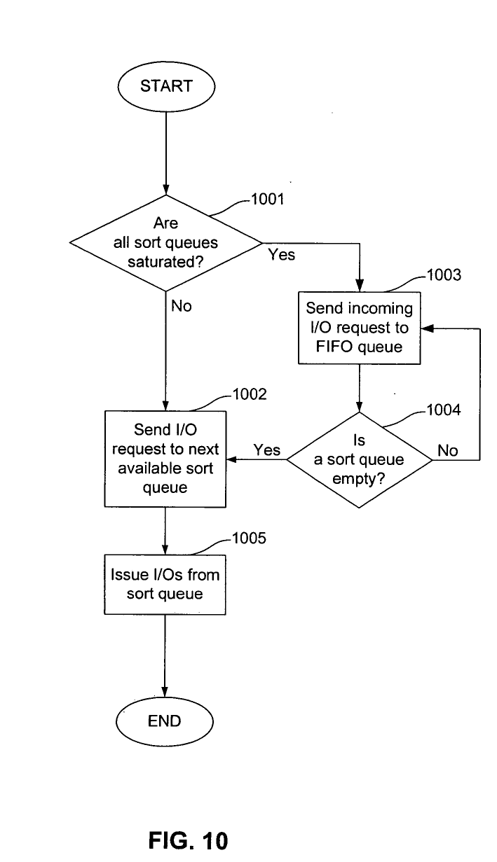

FIG. 2 illustrates the exemplary embodiment which has three sorted queues S1, S2 and S3, a FIFO queue, incoming I/O requests 201 and a storage medium which is typically a hard disk drive in a redundant array. The sort queues and the FIFO queue are implemented in software and are typically stored in main memory. It would be apparent to a person skilled in the relevant arts, that the queues can be stored in any type of memory such as a hard disk or even in non-volatile random access memory (NVRAM) on the RAID controller itself. The queues can also be implemented in hardware. As seen in FIG. 2, the FIFO queue can transfer I/Os to the sort queue and the sort queues can issue I/Os to the storage medium. The incoming I/O requests 201 can be directed to either the sort queues or the FIFO queue. The algorithm governing the movement of I/Os between the FIFO and sort queues, from the sort queues to the disk and from the OS to the FIFO or sort queues is set forth in the flowchart shown in FIG. 10. An exemplary scenario is discussed in FIGS. 3-9.

As shown in FIG. 3, initially all incoming I/O requests 301 are directed to the sort queue S1 which sorts I/Os based on their read or write location to the disk drive. The queue S1 issues sorted I/Os to the disk. At the stage shown in FIG. 3, neither the queue depth nor the latency control number for S1 have been exceeded by the incoming I/O rate.

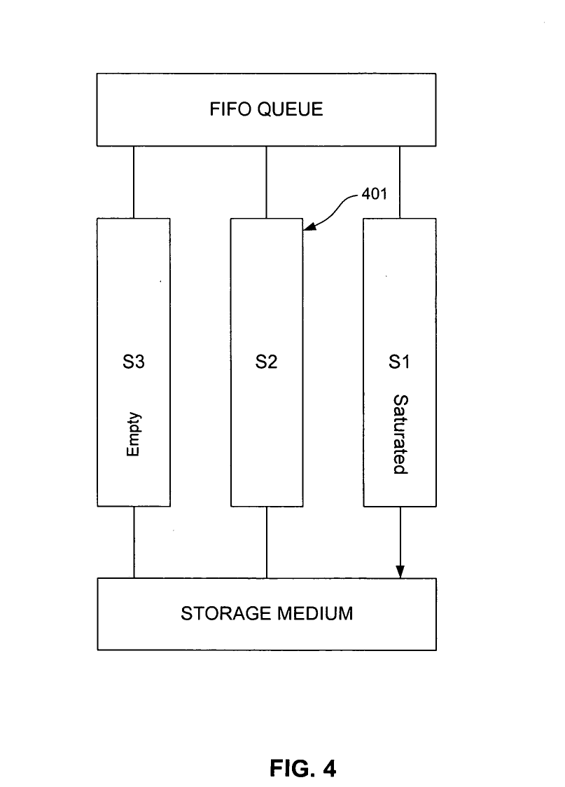

FIG. 4 shows the case when either the queue depth or the latency control number for S1 is exceeded by the incoming I/Os. In this case, incoming I/Os 401 are directed to sort queue S2 while the saturated sort queue S1 continues issuing I/Os to the storage medium. Since S1 is in a saturated state, it will not accept any more incoming I/O requests till it has issued all previously received I/Os to disk and is empty.

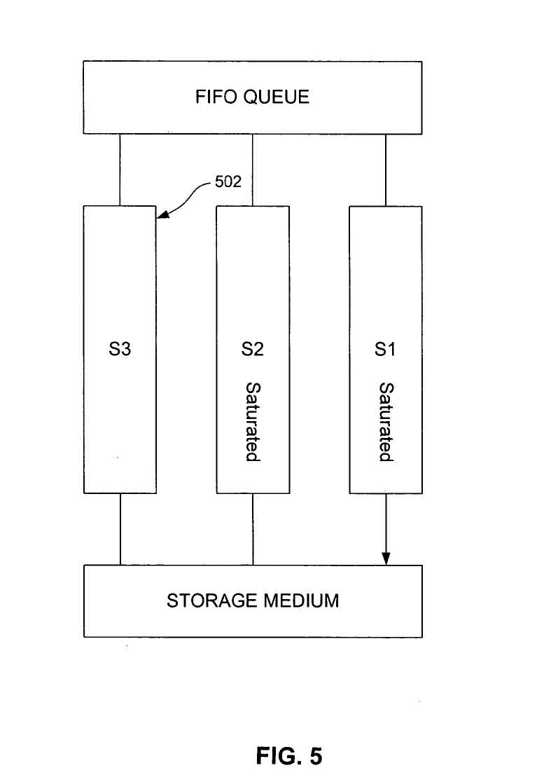

FIG. 5 illustrates the case where sort queue S2 also saturates and incoming I/O requests 502 are directed to sort queue S3. In this case S1 is still saturated and continues issuing sorted I/Os to disk while incoming I/O requests are directed to sort queue S3.

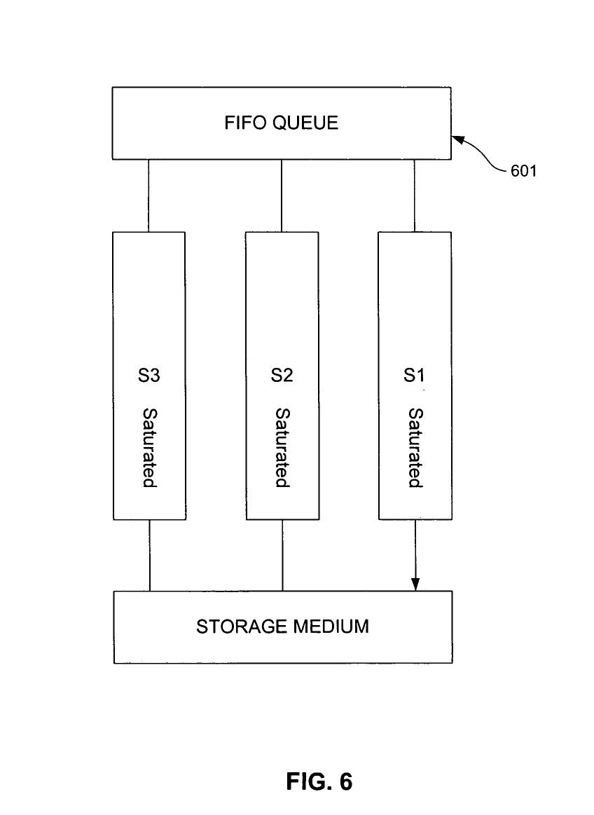

FIG. 6 illustrates the case where all three queues are saturated. In this case incoming I/O requests 601 are directed to the FIFO queue, while sort queue S1 continues issuing I/Os to disk.

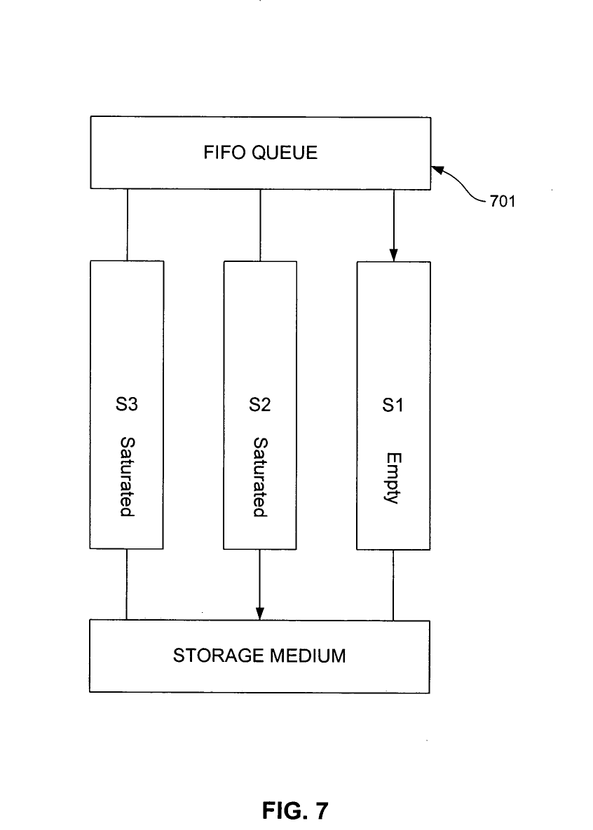

FIG. 7 depicts that case when sort queue S1 is empty while S2 and S3 are saturated. In this case the FIFO queue starts transferring its stored I/Os to S1 while sort queue S2 issues I/Os to disk. The FIFO queue will continue to receive incoming I/O requests 701 until its previously stored I/Os have been transferred to a sort queue.

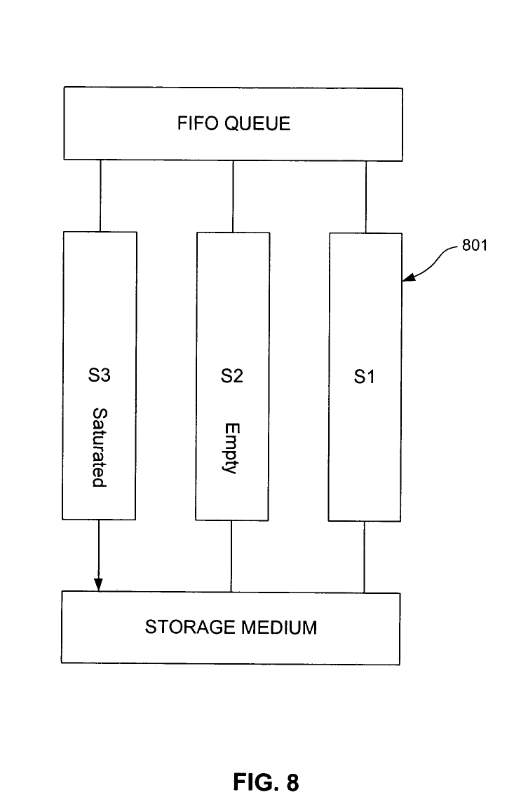

FIG. 8 shows the case where the FIFO queue did not have enough stored I/Os to saturate S1, S2 has issued all stored I/Os to disk and S3 is still saturated. Therefore, since S1 is not saturated, incoming I/O requests 801 are once again directed towards S1, while queue S3 issues I/Os to the storage medium.

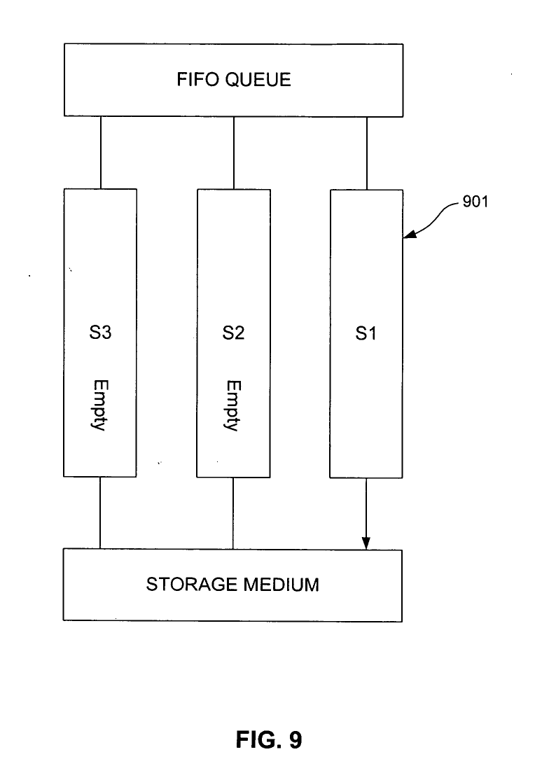

FIG. 9 shows a case where S3 is empty again and the system is back to the initial state where sort queue S1 accepts incoming I/Os 901 and issues them to disk.

It is possible that the FIFO queue is never empty if the incoming I/O rate is extremely high. In that case, the FIFO queue will continue receiving incoming I/Os and transferring the I/Os to the sort queues when they become available. This methodology maintains a fair algorithm while minimizing disk head movement.

An exemplary method employing the features of the invention proceeds along the following steps as shown in the flowchart of FIG. 10.

When an incoming I/O request is received, it is first determined whether all sort queues are saturated in step 1001. A sort queue is saturated if its queue depth has been exceeded or the latency control number has been exceeded. Once a queue is saturated it will not accept any more I/Os till all the stored I/Os have been issued to disk.

If all sort queues are not saturated, then incoming I/O requests are directed to the next available sort queue in step 1002.

If all sort queues are saturated, incoming I/O requests are directed to the FIFO queue in step 1003.

The FIFO queue periodically checks to see if a sort queue is available (i.e., it is empty) in step 1004.

If there is an empty sort queue available then the FIFO queue transfers its stored I/Os to the empty sort queue in step 1002.

In step 1005, I/Os are issued continuously from the sort queue having the foremost I/Os to the disk in the array.

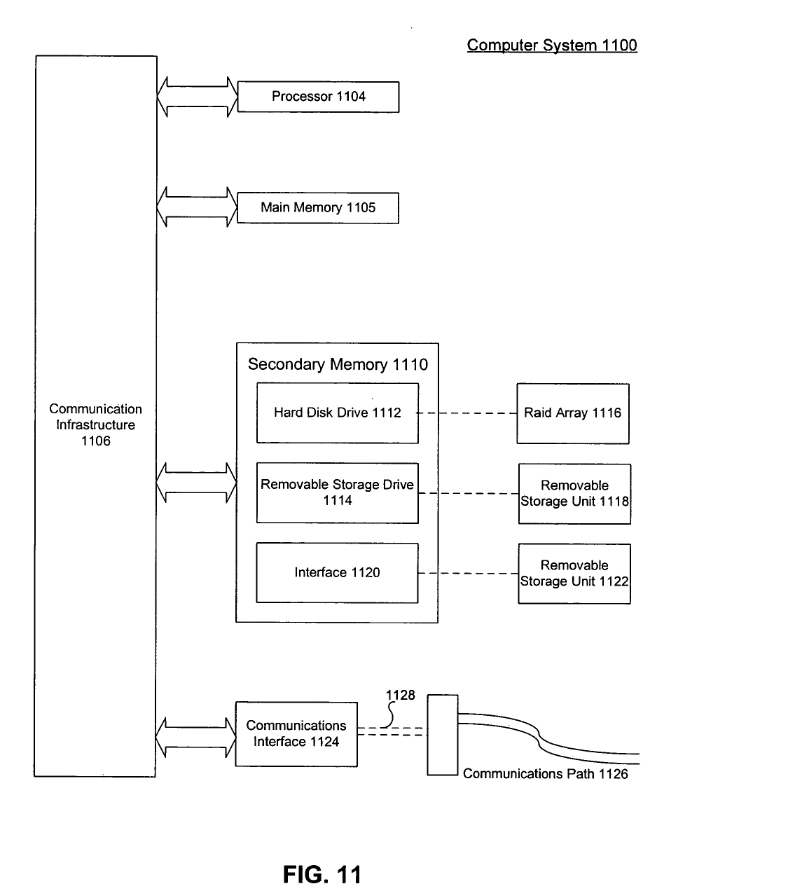

The following description of a general purpose computer system is provided for completeness. The present invention can be implemented in hardware, or as a combination of software and hardware. Consequently, the invention may be implemented in the environment of a computer system or other processing system. An example of such a computer system 1100 is shown in FIG. 11. The computer system 1100 includes one or more processors, such as processor 1104. Processor 1104 can be a special purpose or a general purpose digital signal processor. The processor 1104 is connected to a communication infrastructure 1106 (for example, a bus or network). Various software implementations are described in terms of this exemplary computer system. After reading this description, it will become apparent to a person skilled in the relevant art how to implement the invention using other computer systems and/or computer architectures.

Computer system 1100 also includes a main memory 1105, preferably random access memory (RAM), and may also include a secondary memory 1110. The secondary memory 1110 may include, for example, a hard disk drive 1112, and/or a RAID array 1116, and/or a removable storage drive 1114, representing a floppy disk drive, a magnetic tape drive, an optical disk drive, etc. The removable storage drive 1114 reads from and/or writes to a removable storage unit 1118 in a well known manner. Removable storage unit 1118, represents a floppy disk, magnetic tape, optical disk, etc. As will be appreciated, the removable storage unit 1118 includes a computer usable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

Computer system 1100 may also include a communications interface 1124. Communications interface 1124 allows software and data to be transferred between computer system 1100 and external devices. Examples of communications interface 1124 may include a modem, a network interface (such as an Ethernet card), a communications port, a PCMCIA slot and card, etc. Software and data transferred via communications interface 1124 are in the form of signals 1128 which may be electronic, electromagnetic, optical or other signals capable of being received by communications interface 1124. These signals 1128 are provided to communications interface 1124 via a communications path 1126. Communications path 1126 carries signals 1128 and may be implemented using wire or cable, fiber optics, a phone line, a cellular phone link, an RF link and other communications channels.

The terms “computer program medium” and “computer usable medium” are used herein to generally refer to media such as removable storage drive 1114, a hard disk installed in hard disk drive 1112, and signals 1128. These computer program products are means for providing software to computer system 1100.

Computer programs (also called computer control logic) are stored in main memory 1108 and/or secondary memory 1110. Computer programs may also be received via communications interface 1124. Such computer programs, when executed, enable the computer system 1100 to implement the present invention as discussed herein. In particular, the computer programs, when executed, enable the processor 1104 to implement the processes of the present invention. Where the invention is implemented using software, the software may be stored in a computer program product and loaded into computer system 1100 using raid array 1116, removable storage drive 1114, hard drive 1112 or communications interface 1124.

In another embodiment, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof. Thus, the breadth and scope of the present invention should not be limited by any of the above-described exemplary embodiments, but should be defined only in accordance with the following claims and their equivalents.

What is claimed is:

1. A method of increasing I/O performance and controlling I/O latency for reading from or writing to at least one storage medium in a computer system, said storage medium controlled by at least one RAID controller, comprising:
(a) determining an optimal number of sort queues;
(b) determining an optimal queue depth for said sort queues;
(c) determining an optimal latency control number for said sort queues; and
(d) if said queue depth or said latency control number for a first sort queue is exceeded, then directing incoming I/Os to a second sort queue.

2. The method of claim 1, further comprising: creating said sort queues based on parameters obtained from steps (a) and (b).

3. The method of claim 2, further comprising: sorting incoming I/O requests in said sort queues based upon the read or write location of said I/O requests to disk.

4. The method of claim 3, further comprising: issuing said sorted I/O requests from said sort queues to disk.

5. The method of claim 1, further comprising: contemporaneously issuing I/O requests to the disk from said first sort queue while directing incoming I/Os to said second sort queue subsequent to step (d)

6. The method of claim 5, further comprising: directing incoming I/O requests to a FIFO queue if all sort queues are saturated.

7. The method of claim 6, further comprising: transferring stored I/O requests from said FIFO queue to the first available sort queue.

8. The method of claim 1, further comprising: creating sort and FIFO queues for each disk managed by said RAID controller in said computer system.

9. The method of claim 1, further comprising: determining said latency control number by sampling I/O request rates and I/O statistics.

10. The method of claim 1, further comprising: determining said optimal number of sort queues sampling I/O request rates and I/O statistics.

11. The method of claim 1, further comprising: determining said optimal depth of sort queues by sampling I/O request rates and I/O statistics.

12. A computer program product comprising a computer useable medium including control logic stored therein for increasing I/O performance and controlling I/O latency for reading from or writing to at least one storage medium in a computer system, said storage medium controlled by at least one RAID controller, comprising:
first control logic means for enabling the computer to determine an optimal number of sort queues;
second control logic means for enabling the computer to determine an optimal queue depth for said sort queues;
third control logic means for enabling the computer to determine an optimal latency control number for said sort queues; and
fourth control logic means for enabling the computer to direct incoming I/Os to a second sort queue if said queue depth or said latency control number for a first sort queue is exceeded.

13. The computer program product of claim 12, further comprising: fifth control logic means for enabling the computer to create said sort queues based on parameters obtained from said first and second control logic means.

14. The computer program product of claim 12, further comprising: fifth control logic means for enabling the computer to sort incoming I/O requests in said sort queues based upon the read or write location of said I/O requests to disk.

15. The computer program product of claim 14, further comprising: sixth control logic means for enabling the computer to issue said sorted I/O requests from said sort queues to disk.

16. The computer program product of claim 12, further comprising: fifth control logic means for enabling the computer to contemporaneously issue I/O requests to the disk from said first sort queue while directing incoming I/Os to said second sort queue.

17. The computer program product of claim 16, further comprising: sixth control logic means for enabling the computer to direct incoming I/O requests to a FIFO queue if all sort queues are saturated.

18. The computer program product of claim 17, further comprising: seventh control logic means for enabling the computer to transfer stored I/O requests from said FIFO queue to the first available sort queue.

19. The computer program product of claim 12, further comprising: fifth control logic means for enabling the computer to create sort and FIFO queues for each disk managed by said RAID controller in said computer system.

20. The computer program product of claim 12, further comprising: fifth control logic means for enabling the computer to determine said latency control number by sampling I/O request rates and I/O statistics.

21. The computer program product of claim 12, further comprising: fifth control logic means for enabling the computer to determine said optimal number of sort queues by sampling I/O request rates and I/O statistics.

22. The computer program product of claim 12, further comprising: fifth control logic means for enabling the computer to determine said optimal depth of sort queues by sampling I/O request rates and I/O statistics.
